(19) United States
(12) Patent Application Publication
(10) Pub. No.: US 2013/0033645 A1
(43) Pub. Date: Feb. 7, 2013

(54) Multi-Tasking Portable Computing Device for Video Content Viewing

(71) Applicant: Roger J. Jellicoe, San Mateo, CA (US)

(72) Inventor: Roger J. Jellicoe, San Mateo, CA (US)

(73) Assignee: MOTOROLA MOBILITY, INC., Libertyville, IL (US)

(21) Appl. No.: 13/198,889

(22) Filed: Aug. 5, 2011

(51) Int. Cl. H04N 5/445

(52) U.S. Cl. 348/564; 348/E05.104

(57) ABSTRACT

A system and apparatus for modifying content displayed by a portable computing device responsive to an orientation associated with the portable computing device. When in a first orientation, the portable computing device displays video content in a single window of a display device. In one embodiment, the single window fully occupies the display device. Responsive to determining the portable computing device is in a second orientation, a first window and a second window are generated. Video content is displayed in the first window and data associated with an application is concurrently displayed in the second window. For example, the first window occupies a first percentage of the display device and the second window occupies a second percentage of the display device, allowing concurrent viewing of the video content and the data associated with the application.

### FIELD OF THE DISCLOSURE

The present disclosure relates generally to portable computing devices and more particularly to concurrent viewing of video content and additional application data using a portable computing device.

### BACKGROUND

Portable computing devices, such as smartphones or tablet computers, are becoming increasingly powerful and user-friendly. Increased network connectivity has further enhanced portable computing device functionality, allowing portable computing devices to provide a wider range of functionalities and/or data. For example, an increasing number of users use a portable computing device to view video content, such as television programming, movies or other video content.

Further, the network connectivity and computing capability of portable computing devices allows users to perform a variety of functions. For example, users may access web pages, compose emails, view images, edit documents or use other applications using a portable computing device. Users often seek to efficiently use their time by performing additional tasks while viewing video content. For example, users may view web pages, compose emails or perform other tasks during breaks in television programming or may view a web page to obtain additional information about a topic featured in video content being viewed.

However, current portable computing devices, and other video presentation devices, interrupt or stop video content viewing to allow users to perform additional tasks. For example, conventional tablet computers present video content using their entire display area, requiring a user to stop viewing video content to initiate or view a different application, such as a web browser. This configuration prevents a user from concurrently viewing video content and accessing a web page or interacting with a different application. Other conventional portable computing devices overlay web information, such as search results, on video content. However, the overlaid information obscures portions of the viewed video content.

### BRIEF DESCRIPTION OF THE DRAWINGS

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a computing system in accordance with some embodiments.

FIG. 2 is a block diagram of a portable computing device in accordance with some embodiments.

FIG. 3 is a flow chart of a method for displaying video content and an application responsive to orientation of a portable computing device in accordance with some embodiments.

FIG. 4 is a diagram of an example of automatically displaying an application in addition to video content responsive to modification of portable device orientation in accordance with some embodiments.

Skilled artisans will appreciate that elements in the Figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing the specific details that are pertinent to understanding the embodiments of the present invention so as not to obscure the disclosure with details that will be readily apparent to those of ordinary skill in the art having the benefit of the description herein.

### DETAILED DESCRIPTION

The following disclosure describes a method and apparatus for modifying content displayed by a portable computing device responsive to an orientation associated with the portable computing device. Responsive to determining the portable computing device is in a first orientation, video content is displayed in a single window of a display device of the portable computing device. For example, responsive to determining the portable computing device has a first orientation relative to a reference plane, video content is presented on the portable computing device in a single window shown on the display device. In one embodiment, the single window fully occupies the display device. Responsive to determining the portable computing device is in a second orientation, a first window and a second window are generated. The video content is displayed in the first window and data associated with an application is concurrently displayed in the second window. For example, the first window occupies a first percentage of the display device and the second window occupies a second percentage of the display device. In one embodiment, the application is determined from predetermined data stored by the portable computing device.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention.

System Overview

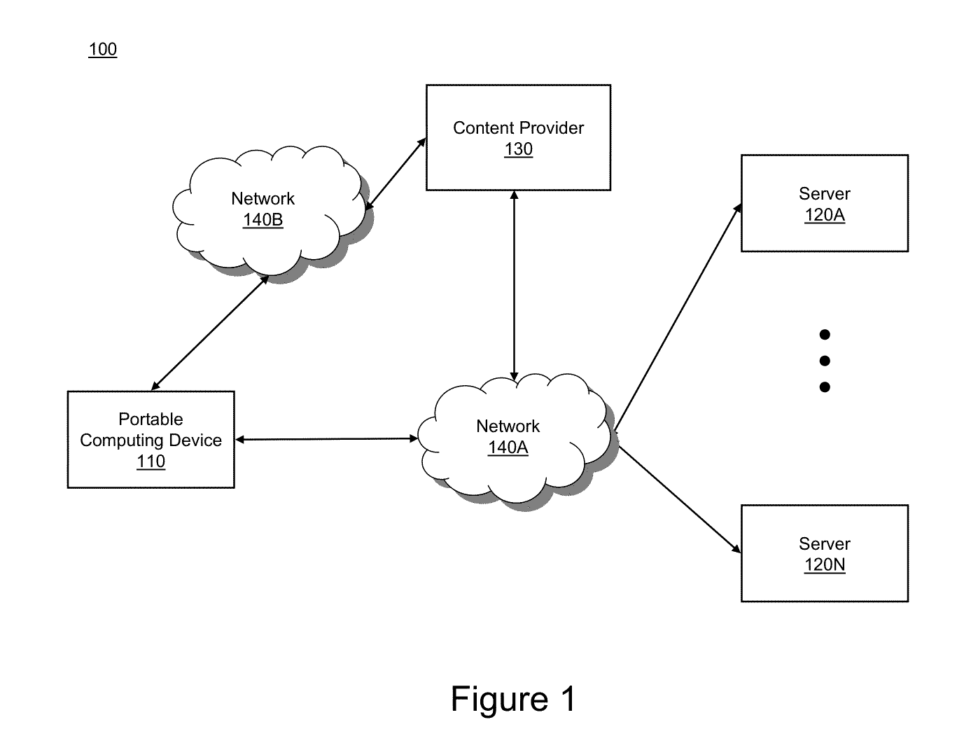

FIG. 1 is a block diagram of one embodiment of a computing system 100. In the embodiment shown by FIG. 1, the computing system 100 includes a portable computing device 110, one or more servers 120A, 120N (also referred to individually and collectively using reference number 120), a content provider 130 and one or more networks 140A, 140B (also referred to individually and collectively using reference number 140). However, in different embodiments, the computing system 100 may include different and/or additional components than those depicted in FIG. 1.

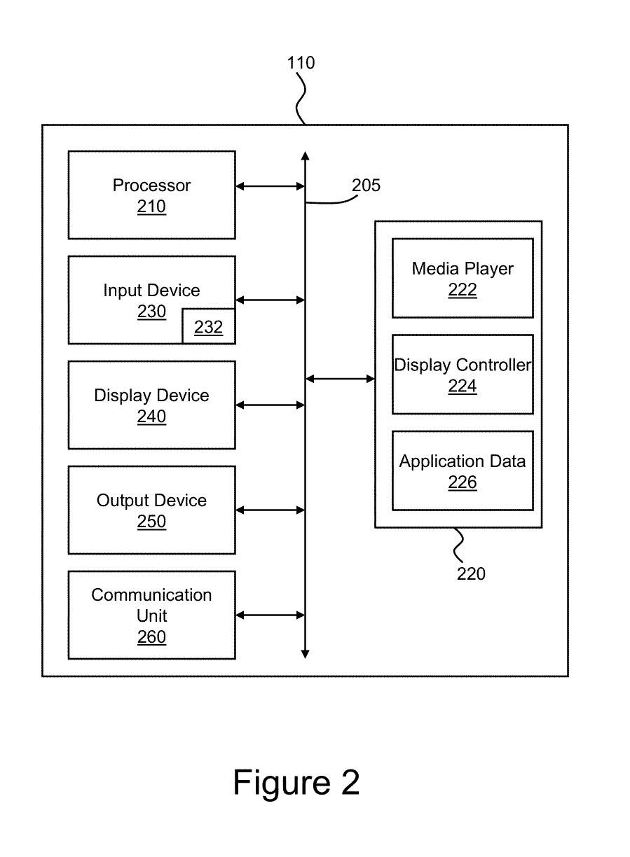

The portable computing device 110 is any device with data processing and data communication capabilities. Examples of a portable computing device 110 include a smartphone, a tablet computer, a netbook computer, a laptop computer or any other suitable device. The portable computing device 110 receives data from one or more servers 120A, 120N and/or from a content provider 130 via the network 140. In one embodiment, the portable computing device 110 receives executable data or instructions from a server 120 via the network 140 that, when executed by the portable computing device 110, execute an application enabling user interaction with content. Additionally, the portable computing device 110 may receive video content or other content from a content provider 130 and present the received content to a user. For example, the portable computing device 110 displays video content from a content provider 130 on a display device. The portable computing device 110 is further described below in conjunction with FIG. 2.

Servers 120A, 120N are computing devices having data processing and data communication capabilities that exchange data with the portable computing device 110 via the network 140. For example, a server 120 provides data such as a web page, audio content, video content or other content via the network 140 to the portable computing device 110 and/or receives data from a portable computing device 110 via the network 140. A server 120 may push data to the portable computing device 110 via the network 140 and/or a portable computing device 110 may pull data from a server 120 via the network 140. For example, a server 120 is a web server from which the portable computing device 110 receives or retrieves web pages.

The content provider 130 comprises one or more computing devices transmitting video content, or other content, to the portable computing device 110 via a network 140. In one embodiment, the content provider 130 and a server 120 communicate with the portable computing device 110 using the same network 140A. Alternatively, a server 120 communicates with the portable computing device 110 using a first network 140A and the content provider 30 communicates with the portable computing device 110 using a second network 140B. For example, the content provider 130 is a video hosting web site, television provider or another source of video content. As another example, the content provider 130 is a streaming video source transmitting streaming video content. As another example, the content provider 130 is a television provider communicating television programming to the portable computing device 110. In one embodiment, the content provider 130 transmits video content using a packet-switched format, such as Transmission Control Protocol/Internet Protocol (TCP/IP). Alternatively, the content provider 130 transmits video content using a different format, such as radio frequency broadcast, satellite signal or cable television format. In another embodiment, the content provider 130 transmits video content using more than one of the above-identified formats.

A network 140 is a conventional type for data, video and/or audio transmission. In various embodiments, the network 140 is a wired network, a wireless network or a combination of wireless and wired networks. The network 140 may have any number of configurations such as a star configuration, a token ring configuration or another configuration known in the art. Furthermore, the network 140 may comprise a local area network (LAN), a wide area network (WAN) (e.g., the Internet), and/or any other interconnected data path across which multiple devices may communicate. In yet another embodiment, the network 140 may be a peer-to-peer network. The network 140 may also be coupled to or include portions of a telecommunications network for sending data in a variety of different communication protocols, such as those used for TCP/IP, satellite link and/or cable television communication. For example, the network 140 may transmit voice data using one or more of a Global System for Mobile (GSM) communication system, Code Division Multiple Access (CDMA) system, Universal Mobile Telecommunications System (UMTS) or any other suitable protocols.

A network 140 may also transmit data using one or more of General Packet Radio Service (GPRS), third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax) or any other suitable protocol. In yet another embodiment, the network 140 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email or other types of data known in the art.

In one embodiment, the first network 140A and the second network 140B may have different configurations. For example, the first network 140A is configured to transmit data using TCP/IP, or another form of packet-based communication, while the second network 140B is configured to transmit television signals using broadcast, cable or satellite protocols. For example, the first network 140A is a Local Area Network or a Wide Area Network coupled to a server 120 and the second network 140B is a cable television provider or a satellite television provider coupled to the content provider 130. Alternatively, the computing device 110 communicates with the content provider 130 and one or more servers 120 using a single network 140.

FIG. 2 is a block diagram of one embodiment of a portable computing device 110. In the embodiment shown by FIG. 2, the portable computing device 110 includes a processor 210, a storage device 220, an input device 230, a display device 240, an output device 250 and a communication unit 260 that are coupled together via a bus 205. However, in different embodiments, the portable computing device 110 may include different and/or additional components than those illustrated by FIG. 2.

The processor 210 processes data or instructions and may comprise various computing architectures. For example, the processor 210 may process data or instructions using a complex instruction set computer (CISC) architecture, a reduced instruction set computer (RISC) architecture, an architecture implementing a combination of instruction sets or any other suitable instruction set. Although FIG. 2 shows a single processor 210, in other embodiments, the portable computing device 110 may include multiple processors. The processor 210 transmits, processes and/or retrieves data from the storage device 220, the input device 230, the display device 240, the output device 250 and/or the communication unit 260.

The storage device 220 stores data and/or instructions that, when executed by the processor 210, cause the processor 210 to perform one or more actions or to provide one or more types of functionality. The data and/or instructions included in the storage device 220 may comprise computer-readable code that, when executed by the processor 210, perform one or more of the methods described herein and/or provide at least a subset of the functionality described herein. The storage device 220 may comprise a dynamic random access memory (DRAM), a static random access memory (SRAM), a hard disk, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), a Flash memory or another memory device known in the art. The storage device 220 may be a persistent storage device, a non-persistent storage device or a combination of a persistent storage device and a non-persistent storage device in various embodiments. The storage device 220 is coupled to the processor 210, the input device 230, the display device 240, the output device 250 and the communication unit 260 via the bus 205.

In the embodiment shown by FIG. 2, the storage device 220 includes a media player 222, a display controller 224 and application data 226. The media player 222 comprises instructions that, when executed by the processor 210, present content using the display device 240. For example, the media player 222 presents video content using the display device 240. In one embodiment, the media player 222 also presents additional content using the output device 250. For example, the media player 222 presents audio content associated with video content using an output device 250 such as a speaker and/or earphones. In one embodiment, the media player 222 processes video content retrieved from the storage device 220 or received from a content provider 130 or from a server 120 to display the video content. For example, the media player 222 visually presents data having one or more formats using the display device 240. Example data formats include Moving Picture Experts Group (MPEG) data, Audio Video Interleaved (AVI) data, Small Web Format (SWF) data, Flash Video data or any other suitable type of video content.

The display controller 224 comprises instructions that, when executed by the processor 210, manage presentation of data on the display device 240. The display controller 224 initializes and maintains a display space including data and/or applications currently being executed by the portable computing device 110. In one embodiment, the display controller 224 generates one or more windows including data and/or applications and displays one or more of the generated windows using the display device 240. Additionally, the display controller 224 receives input from one or more of the processor 210, the communication unit 260 or the input device 230 to show a window or to modify the sizing, position or orientation of a window. For example, the display controller 224 determines an initial position of a window on the display device 240 and resizes, moves or otherwise alters the appearance of a displayed window responsive to a command or an instruction received from the processor 210, the input device 230 or the communication unit 260. As another example, the display controller 224 generates and displays additional windows on the display device 240 responsive to receiving an input.

In one embodiment, the display controller 224 also monitors and controls display settings associated with the display device 240. For example, the display controller 224 modifies the brightness and/or contrast of the display device 240. In one embodiment, the display controller 224 also transmits control signals to the processor 210 and/or to the display device 240 for modifying power usage of the display device 240.

The application data 226 comprises instructions that, when executed by the processor 210, implement one or more applications providing functionality to a user of the portable computing device 110 or to the portable computing device 110. In one embodiment, the application data 226 includes data for executing a web browser, allowing the portable computing device 110 to receive input identifying a content provider 130 or a server 120 via the input device 230 and to retrieve data from the identified content provider 130 or server 120 via the network 140. For example, the application data 226 allows a user to identify and retrieve one or more web pages maintained from a server 120. However, the application data 226 may also include instructions that, when executed by the processor 210, implement additional types of functionality, such as a text editor, a word processor, an email client, a messaging client, a calendar, an address book, a telephone dialer, an image gallery or any other suitable type of functionality.

In one embodiment, the storage device 220 may also include video content or other content that is displayed via the display device 240. For example, the media player 222 accesses and displays video content stored by the storage device 220, allowing a user to view video content locally stored by the portable computing device 110.

The input device 230 is any device configured to receive input and to communicate the received input to the processor 210, to the storage device 220 or to another component of the portable computing device 110. For example, the input device 230 comprises a cursor controller, a touch-sensitive display or a keyboard. In one embodiment, the input device 230 includes an alphanumeric input device, such as a keyboard, a key pad, representations of such created on a touch-sensitive display or another device adapted to communicate information and/or commands to the processor 210 or to the storage device 220. In another embodiment, the input device 230 comprises an input device for communicating positional data as well as data or commands to the processor 210 or to the storage device 220 such as a joystick, a mouse, a trackball, a stylus, a touch-sensitive display, directional keys or another suitable input device known in the art.

In one embodiment, the input device 230 includes an orientation sensor 232 determining an orientation associated with the portable computing device 110. For example, the orientation sensor 232 comprises a tilt sensor measuring tilting in two or more axes of a reference plane. In one embodiment, the orientation sensor 232 comprises an accelerometer determining an orientation of the portable computing device 110. In one embodiment, the orientation sensor 232 generates a first control signal responsive to determining the portable computing device 110 has a first orientation and generates a second control signal responsive to determining the portable computing device has a second orientation. For example, the orientation sensor 232 generates the first control signal responsive to determining the portable computing device 110 has a first orientation relative to a reference plane and generates the second control signal responsive to determining the portable computing device 110 has a second orientation relative to the reference plane. For example, the orientation sensor 232 generates the first control signal responsive to being perpendicular to a reference plane and generates the second control signal responsive to being parallel to the reference plane. In one embodiment, the first orientation and the second orientation are orthogonal to each other, such as a landscape orientation and a portrait orientation.

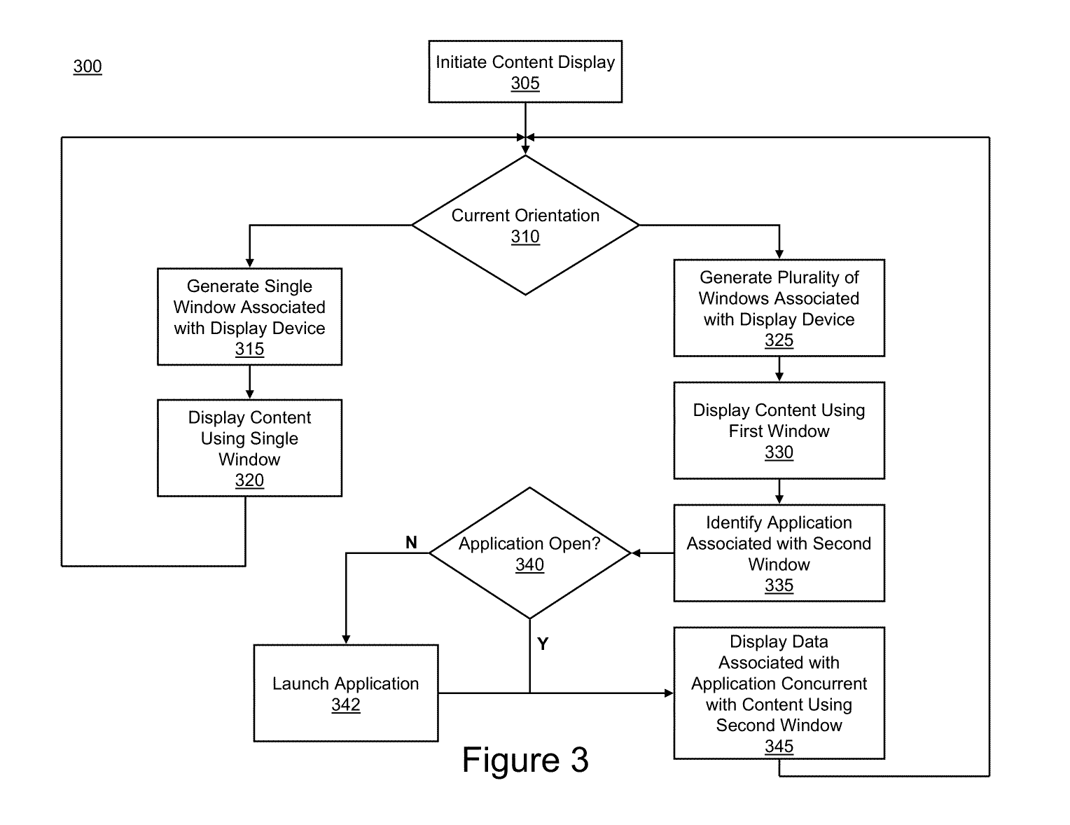

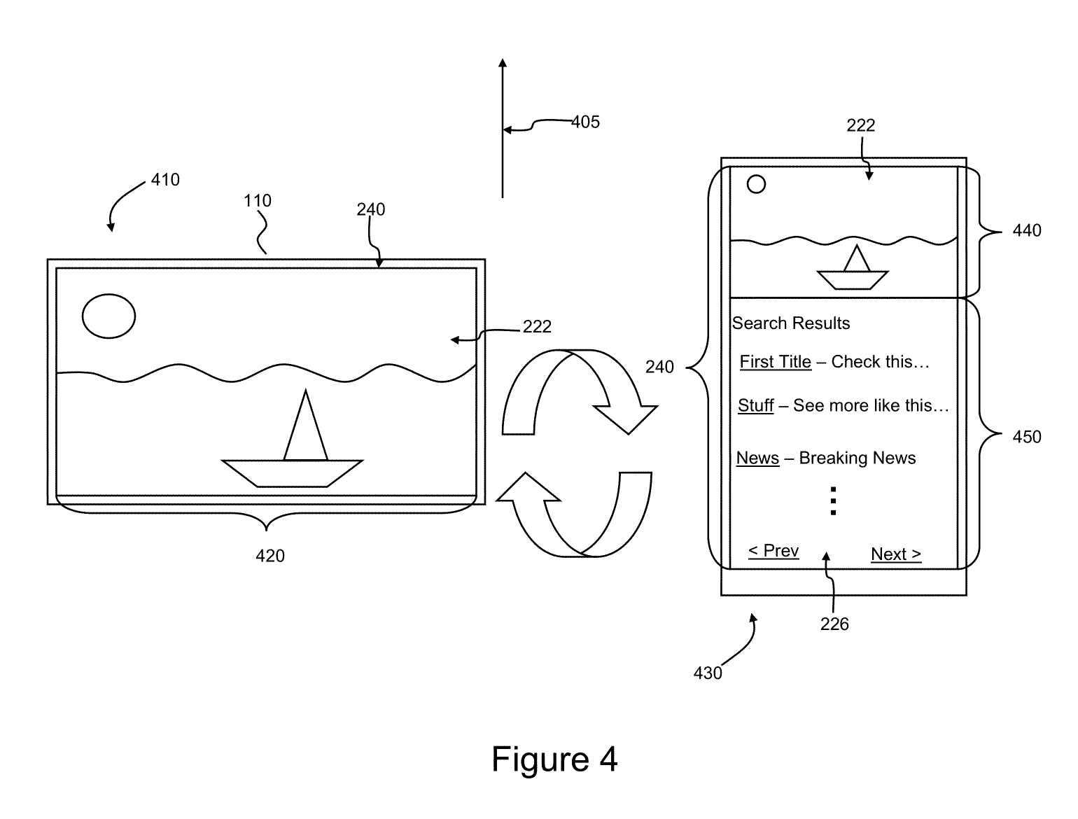

In one embodiment, the control signal generated by the orientation sensor 232 is communicated to the display controller 224 via the bus 205. Responsive to receiving the control signal, the display controller 224 modifies the display of content on the display device 240. For example, the display controller 224 modifies the orientation, relative to a reference plane, of content displayed by the display device 240 responsive to the control signal from the orientation sensor 232. Additionally, the display controller 224 may also modify the size and/or positioning of one or more windows or display different and/or additional windows responsive to the control signal from the orientation sensor 232. For example, the display controller 224 reduces the size of a first window and concurrently displays a second window associated with an application responsive to receiving a first control signal from the orientation sensor 232 and increases the size of the first window while removing the window associated with the predetermined application from the display device 240 responsive to receiving a second control signal from the orientation sensor 232. Modification of the content of the content and/or data display via the display device 240 responsive to data from the orientation sensor 232 is further described below in conjunction with FIGS. 3 and 4.

The display device 240 is a device that displays electronic images and/or data. For example, the display device 240 comprises an organic light emitting diode display (OLED), a liquid crystal display (LCD) or any other device such as a monitor. In one embodiment, the display device 240 includes a touch-sensitive transparent panel for receiving data or allowing other interaction with the images and/or data displayed by the display device 240.

The output device 250 comprises one or more devices that convey data or information to a user of the portable computing device 110. For example, the output device 250 includes one or more speakers or headphones for presenting audio data to a user. As another example, the output device 250 includes one or more light emitting diodes (LEDs) or other light sources to provide visual data to a user. As another example, the output device 250 includes one or more devices for providing vibrational, or haptic, feedback to a user. The above are merely examples of an output device 250 and the output device 250 may include one or more devices for providing auditory output, tactile output, visual output, any combination of the preceding or any other suitable form of output.

The communication unit 260 transmits data from the portable computing device 110 to the network 140 or to other portable computing devices 110 and/or receives data from the network 140 or from other portable computing devices 110. In one embodiment, the communication unit 260 comprises a wireless transceiver that transmits and/or receives data using one or more wireless communication protocols. For example, the communication unit 260 includes one or more wireless transceivers transmitting and/or receiving data using one or more wireless communication protocols, such as IEEE 802.11 a/b/g/n (WiFi), Global System for Mobile (GSM), Code Division Multiple Access (CDMA), Universal Mobile Telecommunications System (UMTS), General Packet Radio Service (GPRS), third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax), BLUETOOTH® or another wireless communication protocol. In another embodiment, the communication unit 260 is a network adapter or other type of wired communication port for communicating with the network 140 or with another portable computing device 110 using a wired communication protocol, such as Universal Serial Bus (USB), Ethernet or another suitable wired communication protocol. In yet another embodiment, the communication unit 260 comprises a combination of one or more transceivers and a wired network adapter, or similar wired device.

Methods

FIG. 3 is a flow chart of a method 300 for displaying video content and data associated with an application responsive to orientation of a portable computing device 110 in accordance with some embodiments. In one embodiment, the steps illustrated by the method 300 shown by FIG. 3 are implemented by instructions for performing the described actions embodied or stored within a computer readable storage medium that, when executed by a processor 210, provide the functionality further described below. Examples of a computer readable storage medium, such as the storage device 220, include flash memory, random access memory (RAM) or any other suitable medium known to one skilled in the art. The method 300 may be implemented in embodiments of hardware, software or combinations of hardware and software. Moreover, in some embodiments, the method 300 includes different and/or additional steps than those shown by FIG. 3.

Display of content using the display device 240 of the portable computing device 110 is initiated 305. For example, a media player 222 included in the portable computing device 110 is initialized 305. In one embodiment, the media player 222 is initialized 305 responsive to an input received by the input device 230 or by the communication unit 260. In one embodiment, the media player 222 retrieves video content from the storage device 220 included in the portable computing device 110. Alternatively, the media player 222 receives video content from a content provider 130 or from a server 120 via a network 140 and the communication unit 260.

The content to be displayed is communicated from the media player 222 to the display controller 224, which determines 310 a current orientation of the portable computing device 110. For example, the display controller 224 initially determines a location on the display device 240 for a window including content from the media player 222. The display controller 224 also receives a control signal from an orientation sensor 232 identifying the current orientation of the portable computing device 110. For example, the orientation sensor 232 communicates a first control signal to the display controller 224 responsive to determining the portable computing device 110 has a first orientation relative to a reference plane and communicates a second control signal to the display controller 224 responsive to determining the portable computing device 110 has a second orientation relative to the reference plane. Based on the control signal received from the orientation sensor 232, the display controller 224 determines 310 the current orientation of the portable computing device 110.

Responsive to determining 310 that the portable computing device 110 has a first orientation relative to a reference plane, the display controller generates 315 a single window and displays 320 content using the single window. In one embodiment, the single window fully occupies the display device 240, occupies substantially the full area of the display device 240 or occupies the majority of the display device 240, allowing the content to be viewed in a full-screen format or in a nearly full-screen format. For example, determining 310 the portable computing device 110 has a first orientation causes the display controller 224 to generate 315 a single window occupying the display device 240 and to display 320 content from the media player 222 using the single window. After displaying 320 the content in the single window, the display controller 224 continues to determine 310 the orientation of the portable computing device 110, allowing display of the content to be dynamically modified based on changes in the portable computing device 110 orientation.

Responsive to determining 310 the portable computing device 110 has a second orientation relative to the reference plane, the display controller 224 generates 325 a plurality of windows for presentation by the display device 240. For example, responsive to receiving a second control signal from the orientation sensor 232, the display controller 224 generates 325 a first window and a second window. However, in different embodiments, the display controller 224 may generate 325 a greater number of windows.

The display controller 224 then displays 330 the content on the display device 240 using the first window. For example, the display controller 224 associates the first window with the media player 222 and displays 330 video content using the first window. The display controller 224 also identifies 335 an application associated with a second window and determines 340 whether the application associated with the second window is open. For example, the display controller 224 determines 340 if the processor 210 is currently executing instructions associated with the identified application associated with the second window.

Responsive to determining 340 that the application associated with the second window is not open, the display controller 224 communicates with the processor 210 to launch 342 the application associated with the second window. For example, the display controller 224 communicates an instruction identifying the application associated with the second window and the location of the second window on the display device 240 to the processor 210. Responsive to the instruction from the display controller 224, the processor 210 launches 342 the identified application by executes data associated with the identified application associated with the second window. This allows the identified application to be launched 224 responsive to a change in the orientation of the portable computing device 110, simplifying user access to the identified application.

After the identified application is launched 342, or responsive to the display controller 224 determining 340 that the identified application is open, the display controller 224 displays 345 data associated with the identified application on the display device 240 using the second window concurrent the content displayed 330 using the first window. For example, the first window is displayed in a first percentage of the display device 240 while the second window is concurrently displayed in a second percentage of the display device 240. Thus, the display controller 224 concurrently displays the first window and the second window on the display device 240, allowing a user to view the content and the identified application at the same time.

In one embodiment, the display controller 224 identifies 335 the application associated with the second window by accessing the storage device 220 and identifying a predetermined application, such as a default application or a previously-identified application from stored data. Alternatively, the display controller 224 initially displays a prompt or menu in the second window allowing a user to manually identify 335 the application associated with the second window and displayed 345 in the second window. In another embodiment, the display controller 224 identifies 335 the application based on the video content displayed in the first window. For example, the display controller 224 identifies 335 an application associated with the displayed video content or identifies a web page to be accessed by a web browser based on the displayed video content.

While the first window and the second window are concurrently displayed, the display controller 224 continues to determine 310 the orientation of the portable computing device 110. For example, if the display controller 224 receives a first control signal from the orientation sensor 232 when the first window and the second window are concurrently displayed, the display controller 224 generates 315 the single window and displays 320 the content in the single window rather than continuing to concurrently display the first window and the second window. Thus, as the orientation of the portable computing device 110 changes, the display controller 224 dynamically modifies the number of windows and positioning of windows on the display device 240.

Example Operation

FIG. 4 is a diagram of an example of automatically displaying data associated with an application concurrently with displaying video content in response to mobile device orientation in accordance with some embodiments. For purposes of illustration, the example shown by FIG. 4 describes orientation of the portable computing device 110 relative to a reference plane 405, illustrated by a vertical line in FIG. 4. However, in other embodiments, the reference plane may have any orientation.

FIG. 4 shows a first orientation 410 of the portable computing device 110 that is orthogonal to the reference plane 405. In the first orientation 410, the orientation sensor 232 included in the portable computing device 110 transmits a first control signal to the display controller 224 of the portable computing device 110. Responsive to receiving the first control signal, the display controller 224 determines that the portable computing device 110 has the first orientation 410 and generates a single window 420 presenting data from a media player 222. In the example of FIG. 4, the single window 420 occupies the complete display device 240 or occupies substantially all of the display device 240 to allow full-screen viewing of video content shown by the media player 222. However, in other embodiments, the percentage of the display device 240 occupied by the single window 420 varies.

In the example of FIG. 4, the portable computing device 110 is repositioned from the first orientation 410 to a second orientation 430 relative to the reference plane 405. For purposes of illustration, FIG. 4 shows an embodiment where the second orientation 430 is parallel to the reference plane 405. Hence, in the example of FIG. 4, the first orientation 410 is orthogonal to the second orientation 430. In the second orientation 430, the orientation sensor 232 included in the portable computing device 110 transmits a second control signal to the display controller 224 of the portable computing device 110. Responsive to receiving the second control signal, the display controller 224 determines that the portable computing device 110 has the second orientation 430 and generates a first window 440 and a second window 450. The display controller 224 also identifies an application from the application data 226 that is associated with the second window 450 and concurrently displays data associated with the identified application in the second window 450 while displaying video content from the media player 222 in the first window 440. In one embodiment, the first window 440 occupies a first percentage of the display device 240 and the second window 450 occupies a second percentage of the display device 240. In the example shown by FIG. 4, the first window 440 and the second window 450 are displayed while the portable computing device 110 is in the second orientation 430; however, in other embodiments, a greater number of windows may be displayed while the portable computing device 110 is in the second orientation 430.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “ha . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
responsive to determining a portable computing device is in a first orientation, displaying video content in a single window on a display device of the portable computing device;
determining the portable computing device is in a second orientation;
responsive to determining the portable computing device is in the second orientation, generating a first window and a second window; and
displaying the video content in the first window on the display device and concurrently displaying data associated with an application in the second window on the display device.

2. The method of claim 1, wherein the first orientation is perpendicular to the second orientation.

3. The method of claim 1, wherein the first window occupies a first percentage of the display device and the second window occupies a second percentage of the display device.

4. The method of claim 1, wherein displaying data associated with the application in the second window on the display device comprises:
determining the application associated with the second window and displaying the data associated with the application in the second window of the display device.

5. The method of claim 4, wherein determining the application associated with the second window comprises:
identifying a predetermined application from data included in a storage device.

6. The method of claim 4, wherein determining the application associated with the second window comprises:
determining whether the application associated with the second window is open; and
responsive to determining the application associated with the second window is not open, launching the application associated with the second window.

7. The method of claim 1, wherein displaying data associated with the application in the second window on the display device comprises:
displaying a web page in a web browser in the second window on the display device.

8. The method of claim 7, wherein the web page is based on a user preference.

9. The method of claim 7, wherein the web page is based on the video content concurrently displayed in the first window on the display device.

10. The method of claim 1, wherein the application comprises at least one of a web browser, an email client, a word processor, a text editor, a calendar, an image gallery, an address book, a telephone dialer or a messaging client.

11. The method of claim 1, wherein the single window fully occupies the display device.

12. The method of claim 1, wherein the video content comprises television programming.

13. An apparatus comprising:
a processor;
a display device coupled to the processor;
an orientation sensor coupled to the processor, the orientation sensor determining an orientation associated with the apparatus and generating a first control signal responsive to determining a first orientation associated with the apparatus and generating a second control signal responsive to determining a second orientation associated with the apparatus; and
a storage device coupled to the processor, the display device and the orientation sensor, the storage device including instructions that, when executed by the processor, cause the processor to:
display video content in a single window on the display device responsive to the first control signal; and
display video content in a first window on the display device and concurrently display content associated with an application in a second window on the display device responsive to the second control signal.

14. The apparatus of claim 13, wherein the first orientation is perpendicular to the second orientation.

15. The apparatus of claim 13, wherein the first window occupies a first percentage of the display device and the second window occupies a second percentage of the display device.

16. The apparatus of claim 13, wherein display data associated with the application in the second window on the display device comprises:
determining the application associated with the second window and display the data associated with the application in the second window of the display device.

17. The apparatus of claim 16, wherein determine the application associated with the second window comprises:
identifying a predetermined application from data included in the storage device.

18. The apparatus of claim 16, wherein determine the application associated with the second window comprises:
determining whether the application associated with the second window is open; and
responsive to determining the application associated with the second window is not open, launching the application associated with the second window.

19. The apparatus of claim 13, wherein display data associated with the application in the second window on the display device comprises:
displaying a web page in a web browser in the second window on the display device.

20. The apparatus of claim 19, wherein the web page is based on a user preference.

21. The apparatus of claim 19, wherein the web page is based on the video content concurrently displayed in the first window on the display device.

22. The apparatus of claim 13, wherein the application comprises at least one of a web page, an email client, a word processor, a calendar, an image gallery or a messaging client.

23. The apparatus of claim 13, wherein the single window fully occupies the display device.

24. The apparatus of claim 13, wherein the video content comprises television programming.
